(19) United States
(12) Patent Application Publication
(10) Pub. No.: US 2019/0080292 A1
(43) Pub. Date: Mar. 14, 2019

(54) SYSTEM AND METHOD FOR DETERMINING LEADERSHIP ACCOUNTABILITY AND TRANSPARENCY

(71) Applicant: NUCLEUS VISION, LLC, Grand Cayman (CI)

(72) Inventor: Abdul D. Pridgen, Fort Worth, TX (US)

(21) Appl. No.: 16/130,974

(22) Filed: Sep. 13, 2018

Related U.S. Application Data
(60) Provisional application No. 62/558,054, filed on Sep. 13, 2017.

(51) Int. Cl. G06Q 10/10; G06Q 10/06

(52) U.S. Cl. CPC G06Q 10/1053; G06Q 10/06395

(57) ABSTRACT

A method of determining a person's leadership accountability and transparency includes receiving objective variables associated with the person; determining subjective variables associated with the person; and analyzing the objective variables and the subjective variables to determine a score; the score provides a quantifiable value for a customer to associate with the person's leadership accountability and transparency.

### BACKGROUND

### 1. Field of the Invention

The present invention relates generally to hiring and employment systems, and more specifically, to a system and method for evaluating and determining a potential employee's leadership skills and transparency.

### 2. Description of Related Art

Hiring and employment systems are well known in the art and are effective means to find employees. Common practices typically involve a potential employer interviewing a candidate, during which the candidate is asked to provide information about themselves. Some practices further involve the use of written tests to determine and evaluate skills. Therefore, assessment of potential employees is largely based on responses to written or verbal questions.

One of the problems commonly associated with conventional hiring systems is limited ability of an employer to determine a candidate's genuine leadership accountability and transparency.

Accordingly, although great strides have been made in the area of hiring and employment systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a system for determining leadership accountability and transparency; and

FIG. 2 is a flowchart of the method of FIG.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional hiring systems. Specifically, the present invention provides an improved means to evaluate a potential employee's leadership skills as well as their transparency. It should be understood that the system of the present invention is not limited to employment and hiring practices, and can be utilized within various industries. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

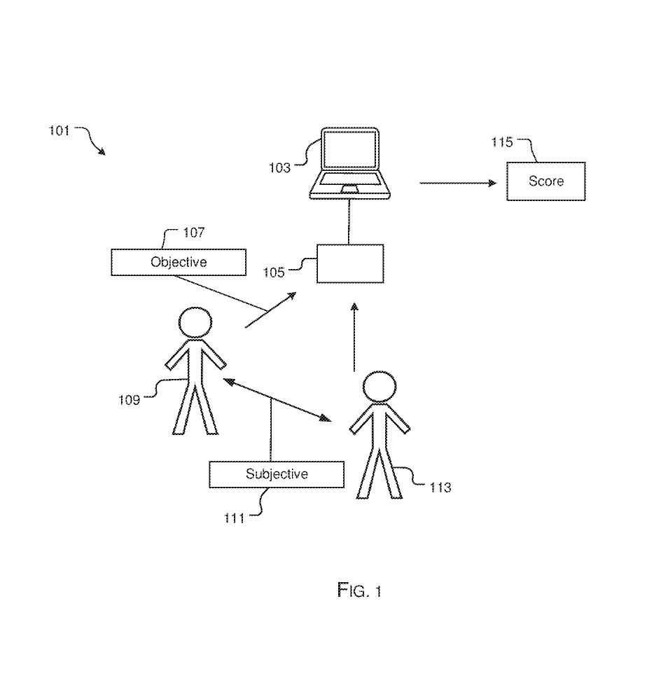

Referring now to the drawings wherein like reference characters identify corresponding or similar elements throughout the several views, FIG. 1 depicts a simplified schematic of a system 101 for determining leadership accountability and transparency in accordance with a preferred embodiment of the present application. It will be appreciated that system 101 overcomes one or more of the above-listed problems commonly associated with conventional hiring systems.

In the contemplated embodiment, system 101 includes a computing device 103 having a platform 105 configured to analyze data. It should be appreciated that platform 105 can be a website configured to receive information or a mobile application. In addition, it should be appreciated that platform 105 can actually be multiple platforms configured to perform various functions, wherein the information determined from each platform is combined into one result.

In the preferred embodiment, platform 105 receives objective variables 107 from a person 109. In hiring practices, the person 109 will be a potential employee, however it should be understood that system 101 could be implemented in other industries. Objective variables are variables that do not change and are therefore are appropriately obtained directly from person 109. It should be appreciated that platform 105 can be configured to receive objective variables via a module within platform 105. Such a module can be configured to provide the person 109 with written questions, multiple choice testing, or other various means to conveniently retrieve variable data.

Platform 107 is further configured to receive subjective data 111 from an analyzer 113 through a subjective variable module. It is contemplated that analyzer 113 can be trained to read person 109 to make subjective determinations. The analyzer can then translate these determinations into a quantifiable result, such as a number, to be implemented within platform 105.

System 101 further includes a score 115 generated through analysis achieved via computing device 103 and platform 105. In the preferred embodiment, the score 115 is a numerical value representative of the person's leadership accountability and transparency based on the objective and subjective variables.

It should be appreciated that one of the unique features believed characteristic of the present application is the incorporation of objective and subjective variables to create a score representative of a person's leadership accountability.

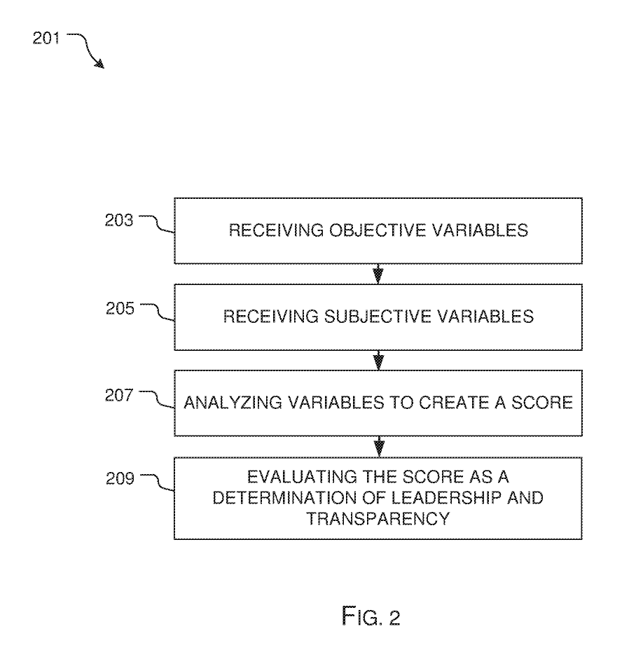

As shown in FIG. 2, a flowchart 201 depicts the method associated with system 101. Objective and subjective variables are received into a computing system, wherein the computing system analyzes the variables to determine a score, as shown with boxes 203, 205, 207. The score is then provided to an employer (or other interested party) as a quantitative measurement of the person's leadership accountability and transparency.

In the present application, objective variables can include but are not limited to leadership tenure, tenure as head of a company, company size, company policy, jurisdictional demographics, education, training, military service, frequency of lawsuit involvement, frequency of information sharing publicly, and frequency of executive positions.

In the present application, subjective variables can include determinations based on information such as disciplinary decisions, public relation involvement, relationships within a company, relationships with labor organizations, accessibility of the person, integrity, level of internal and external transparency, and company success.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for measuring leadership accountability and transparency, the system comprising:
a computing device configured to implement data analysis;
a platform configured to receive variables associated with a person, the platform having:
an objective input module configured to receive one or more objective variables associated with the person; and
a score generated via the computing device through analysis of the objective variables;
wherein the score correlates to the person's leadership accountability and transparency.

2. The system of claim 1, wherein the score is a numerical value.

3. The system of claim 1, wherein the platform further comprises:
a subjective input module configured to receive one or more subjective variables by an analyzer;
wherein the score is generated via analysis of the one or more subjective variables.

4. The system of claim 3, wherein the one or more subjective variables are assigned numerical values by the analyzer.

5. A method of determining a person's leadership accountability and transparency, the method comprising:
receiving a plurality of objective variables associated with the person;
determining a plurality of subjective variables associated with the person; and
analyzing the plurality of objective variables and the plurality of subjective variables to determine a score;
wherein the score provides a quantifiable value for a customer to associate with the person's leadership accountability and transparency.

6. The method of claim 5, wherein analyzing the plurality of objective variable and the plurality of subjective variables is accomplished via an algorithm on a computing device.

7. The method of claim 5, wherein the plurality of objective variables are received through a platform into a computing device.

8. The method of claim 5, wherein the score is a numerical value.
